(19) United States
(12) Patent Application Publication
(10) Pub. No.: US 2014/0147350 A1
(43) Pub. Date: May 29, 2014

(54) Cleaner for Reactor Component Cleaning

(71) Applicant: INTERMOLECULAR, INC., San Jose, CA (US)

(72) Inventor: Brian Kennedy Foster, Mountain View, CA (US)

(73) Assignee: INTERMOLECULAR, INC., San Jose, CA (US)

(21) Appl. No.: 13/685,937

(22) Filed: Nov. 27, 2012

(51) Int. Cl. B01J 19/00

(52) U.S. Cl. CPC B01J 19/0053
USPC 422/600; 134/184

(57) ABSTRACT

A reactor assembly includes a first block having an array of reactors defined therein and a second block having an array of openings defined within a surface of the second block. Each opening of he array of openings is substantially aligned with a corresponding opening of the array of reactors so that that each reactor is associated with at least one corresponding opening defined within the surface of the second block when the surface of the second block is placed on a surface of the first block. The first block is removably sealed against each surface defining the array of openings. A network of channels is defined within the second block. The network of channels is in fluid communication with a fluid source.

### BACKGROUND

Cleaning operations are routinely performed during semiconductor processing. In the case of semiconductor tools designed for high throughput parallel processes, achieving a level of cleaning sufficient to prevent cross-contamination can be complex and time-consuming, due to the fact that tools of this nature may consist of multiple compartments or reactor arrays. An example of such a tool in the context of semiconductor wet processing is the Tempus F-20 tool from Intermolecular. In this case, a variety of tool components and surfaces are potentially exposed to process chemicals during processing—chemicals which can give rise to cross-contamination if not properly removed. Examples of tool components susceptible to contamination include the rinse head, reactor block, reactor cell sleeves, and overhead stirrer impellers. Current procedures used routinely for cleaning these reactor components are non-optimal for various reasons. In some instances, cleaning liquid is unable to be adequately applied to all potentially contaminated surfaces of the reactor components, e.g., dispensing a small volume of cleaning liquid may give incomplete rinsing of surfaces of reactor cells and/or stirrers. In other instances, the application of cleaning liquids may result in undesirable exposure of sensitive hardware components and materials to both cleaning liquid and contaminants, giving potential for cross-contamination between processes performed in the reactor assembly, and for accelerated wear and tear on equipment. An example in the case of the Tempus F-20 would be using the reactor's de-ionized water supply to intentionally over-fill the reactor cells and impellers from the bottom up (so-called “back-filling” of reactor cells and impellers). In addition, the current procedures used are commonly labor-intensive and/or time-consuming and can require disassembly and manual cleaning/drying of hardware components.

### SUMMARY

In some embodiments, a reactor assembly is provided. The reactor assembly includes a first block having an array of reactors defined therein and a second block having an array of openings defined within a surface of the second block. Each opening of the array of openings is substantially aligned with a corresponding opening of the array of reactors so that that each reactor is associated with at least one corresponding opening defined within the surface of the second block when the surface of the second block is placed on a surface of the first block. The first block is removably sealed against each surface defining the array of openings. A network of channels is defined within the second block. The network of channels is in fluid communication with a fluid source.

In some embodiments, a cleaner assembly for a reactor assembly having an array of reactors defined therein is provided. The cleaner assembly includes a flat plate having an upper surface and a lower surface. The cleaner assembly is mountable on the reactor assembly. An array of openings is defined within the lower surface. A network of channels is defined within the flat plate, the network of channels in fluid communication with a fluid source and the array of openings, wherein the flat plate is removably sealed against each surface defining the array of reactors. The fluid source is coupled to the network of channels and is operable to provide a continuous flow of fluid through the network of channels to each of the reactors.

### BRIEF DESCRIPTION OF THE DRAWINGS

FIG. 1 illustrates a simplified schematic diagram providing an overview of the High-Productivity Combinatorial (HPC) screening process for use in evaluating materials, unit processes, and process sequences for the manufacturing of semiconductor devices in accordance with some embodiments.

FIG. 2 illustrates a flowchart of a general methodology for combinatorial process sequence integration that includes site-isolated processing and/or conventional processing in accordance with some embodiments.

FIG. 3 illustrates a schematic view of a reactor assembly and cleaning accessory cross-section in accordance with some embodiments.

FIG. 4 is a simplified schematic diagram of a cross section of a reactor and the rinse head manifold in accordance with some embodiments.

FIG. 5 is a simplified schematic diagram illustrating a cross section of a reactor and the rinse head manifold in accordance with some embodiments.

### DETAILED DESCRIPTION

The following description is provided as an enabling teaching of the invention and its best, currently known embodiments. Those skilled in the relevant art will recognize that many changes can be made to the embodiments described, while still obtaining the beneficial results. It will also be apparent that some of the desired benefits of the embodiments described can be obtained by selecting some of the features of the embodiments without utilizing other features. Accordingly, those who work in the art will recognize that many modifications and adaptations to the embodiments described are possible and may even be desirable in certain circumstances, and are a part of the invention. Thus, the following description is provided as illustrative of the principles of the embodiments of the invention and not in limitation thereof, since the scope of the invention is defined by the claims.

It will be obvious, however, to one skilled in the art, that the embodiments described may be practiced without some or all of these specific details. In other instances, well known process operations have not been described in detail in order not to unnecessarily obscure the present invention.

The embodiments describe a method and apparatus for ensuring the reactors and any impeller assembly for the reactor module are properly cleaned between experiments to avoid cross-contamination. The cross-contamination may cause variability between reactors introduced through the lack of ability to completely clean the reactors. The current techniques of so-called “manual cleaning”, “tip dispense”, and “back-fill” are either too manually intensive or ineffective. The embodiments provide for a cleaner attachment that has a plurality of openings defined on a surface of a block. The block has a plurality of pre-drilled holes or network of channels to direct a cleaning fluid such as de-ionized (DI) water to each of the openings from a fluid source or supply. The openings may be angled to direct the cleaning fluid at different or varied angles toward the side walls of the reactors in some embodiments. The cleaner assembly is also configured to be removably sealed with a surface having openings for the reactor blocks.

Semiconductor manufacturing typically includes a series of processing steps such as cleaning, surface preparation, deposition, patterning, etching, thermal annealing, and other related unit processing steps. The precise sequencing and integration of the unit processing steps enables the formation of functional devices meeting desired performance metrics such as efficiency, power production, and reliability.

As part of the discovery, optimization and qualification of each unit process, it is desirable to be able to (i) test different materials, (ii) test different processing conditions within each unit process module, (iii) test different sequencing and integration of processing modules within an integrated processing tool, (iv) test different sequencing of processing tools in executing different process sequence integration flows, and combinations thereof in the manufacture of devices such as integrated circuits. In particular, there is a need to be able to test (i) more than one material, (ii) more than one processing condition, (iii) more than one sequence of processing conditions, (iv) more than one process sequence integration flow, and combinations thereof, collectively known as “combinatorial process sequence integration,” on a single monolithic substrate without the need for consuming the equivalent number of monolithic substrates per materials, processing conditions, sequences of processing conditions, sequences of processes, and combinations thereof. This can greatly improve both the speed and reduce the costs associated with the discovery, implementation, optimization, and qualification of materials, processes, and process integration sequences required for manufacturing.

High Productivity Combinatorial (HPC) processing techniques have been successfully adapted to wet chemical processing such as etching and cleaning HPC processing techniques have also been successfully adapted to deposition processes such as physical vapor deposition (PVD), atomic layer deposition (ALD), and chemical vapor deposition (CVD).

Systems and methods for HPC processing are described in U.S. Pat. No. 7,544,574, filed on Feb. 10, 2006; U.S. Pat. No. 7,824,935, filed on Jul. 2, 2008; U.S. Pat. No. 7,871,928, filed on May 4, 2009; U.S. Pat. No. 7,902,063, filed on Feb. 10, 2006; and U.S. Pat. No. 7,947,531, filed on Aug. 28, 2009 each of which is incorporated by reference herein. Systems and methods for HPC processing are further described in U.S. patent application Ser. No. 11/352,077, filed on Feb. 10, 2006; U.S. patent application Ser. No. 11/419,174, filed on May 18, 2006; U.S. patent application Ser. No. 11/674,132, filed on Feb. 12, 2007; and U.S. patent application Ser. No. 11/674,137, filed on Feb. 12, 2007. The aforementioned patent applications claim priority from provisional patent application 60/725,186 filed Oct. 11, 2005. Each of the aforementioned patent applications and the provisional patent application are incorporated by reference herein.

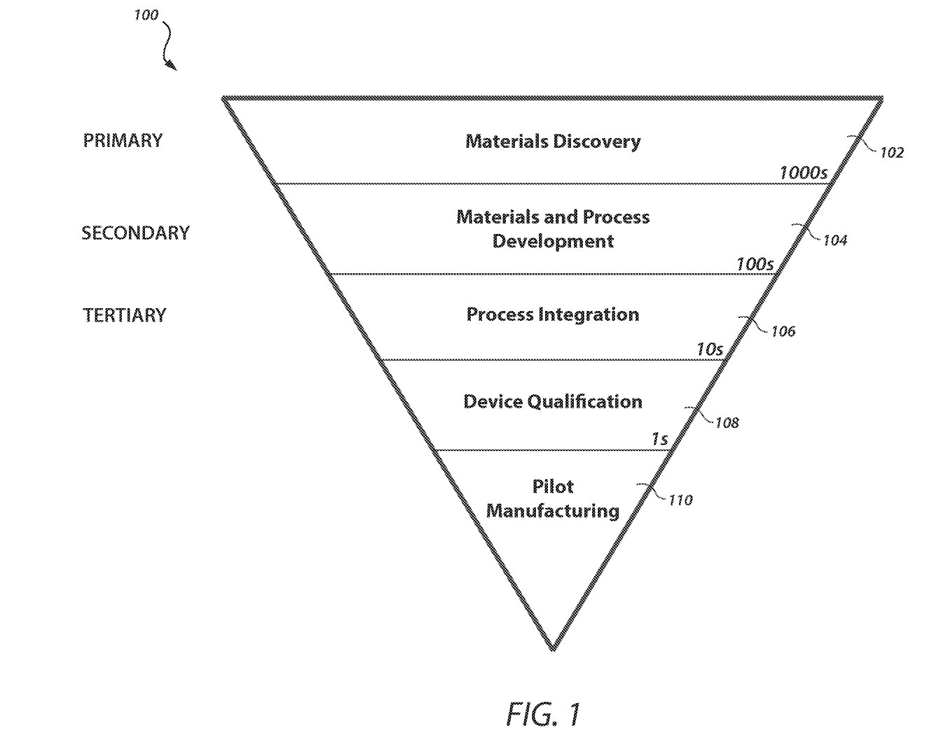

FIG. 1 illustrates a schematic diagram 100 for implementing combinatorial processing and evaluation using primary, secondary, and tertiary screening. The schematic diagram 100 illustrates that the relative number of combinatorial processes run with a group of substrates decreases as certain materials and/or processes are selected. Generally, combinatorial processing includes performing a large number of processes during a primary screen, selecting promising candidates from those processes, performing the selected processing during a secondary screen, selecting promising candidates from the secondary screen for a tertiary screen, and so on. In addition, feedback from later stages to earlier stages can be used to refine the success criteria and provide better screening results.

For example, thousands of materials are evaluated during a materials discovery stage 102. Materials discovery stage 102 is also known as a primary screening stage performed using primary screening techniques. Primary screening techniques may include dividing substrates into coupons and depositing materials using varied processes. The materials are then evaluated, and promising candidates are advanced to the secondary screen, or materials and process development stage 104. Evaluation of the materials is performed using metrology tools such as electronic testers and imaging tools (e.g., microscopes).

The materials and process development stage 104 may evaluate hundreds of materials (i.e., a magnitude smaller than the primary stage) and may focus on the processes used to deposit or develop those materials. Promising materials and processes are again selected, and advanced to the tertiary screen or process integration stage 106 where tens of materials and/or processes and combinations are evaluated. The tertiary screen or process integration stage 106 may focus on integrating the selected processes and materials with other processes and materials.

The most promising materials and processes from the tertiary screen are advanced to device qualification 108. In device qualification, the materials and processes selected are evaluated for high volume manufacturing, which normally is conducted on full substrates within production tools, but need not be conducted in such a manner. The results are evaluated to determine the efficacy of the selected materials and processes. If successful, the use of the screened materials and processes can proceed to pilot manufacturing 110.

The schematic diagram 100 is an example of various techniques that may be used to evaluate and select materials and processes for the development of new materials and processes. The descriptions of primary, secondary, etc. screening and the various stages 102-110 are arbitrary and the stages may overlap, occur out of sequence, be described and be performed in many other ways.

This application benefits from High Productivity Combinatorial (HPC) techniques described in U.S. patent application Ser. No. 11/674,137, filed on Feb. 12, 2007, which is hereby incorporated by reference in its entirety. Portions of the '137 application have been reproduced below to enhance the understanding of the embodiments disclosed herein. The embodiments disclosed enable the application of combinatorial techniques to process sequence integration in order to arrive at a globally optimal sequence of semiconductor manufacturing operations by considering interaction effects between the unit manufacturing operations, the process conditions used to effect such unit manufacturing operations, hardware details used during the processing, as well as material characteristics of components utilized within the unit manufacturing operations. Rather than only considering a series of local optimums, i.e., where the best conditions and materials for each manufacturing unit operation is considered in isolation, the embodiments described below consider effects of interactions introduced due to the multitude of processing operations that are performed and the order in which such multitude of processing operations are performed when fabricating a device. A global optimum sequence order is therefore derived, and as part of this derivation, the unit processes, unit process parameters, and materials used in the unit process operations of the optimum sequence order are also considered.

The embodiments described further analyze a portion or sub-set of the overall process sequence used to manufacture a semiconductor device. Once the subset of the process sequence is identified for analysis, combinatorial process sequence integration testing is performed to optimize the materials, unit processes, hardware details, and process sequence used to build that portion of the device or structure. During the processing of some embodiments described herein, structures are formed on the processed substrate that are equivalent to the structures formed during actual production of the semiconductor device. For example, such structures may include, but would not be limited to, contact layers, buffer layers, absorber layers, or any other series of layers or unit processes that create an intermediate structure found on semiconductor devices. While the combinatorial processing varies certain materials, unit processes, hardware details, or process sequences, the composition or thickness of the layers or structures or the action of the unit process, such as cleaning, surface preparation, deposition, surface treatment, etc. is substantially uniform throughout each discrete region. Furthermore, while different materials or unit processes may be used for corresponding layers or steps in the formation of a structure in different regions of the substrate during the combinatorial processing, the application of each layer or use of a given unit process is substantially consistent or uniform throughout the different regions in which it is intentionally applied. Thus, the processing is uniform within a region (inter-region uniformity) and between regions (intra-region uniformity), as desired. It should be noted that the process can be varied between regions, for example, where a thickness of a layer is varied or a material may be varied between the regions, etc., as desired by the design of the experiment.

The result is a series of regions on the substrate that contain structures or unit process sequences that have been uniformly applied within that region and, as applicable, across different regions. This process uniformity allows comparison of the properties within and across the different regions such that the variations in test results are due to the varied parameters (e.g., materials, unit processes, unit process parameters, hardware details, or process sequences) and not the lack of process uniformity. In the embodiments described herein, the positions of the discrete regions on the substrate can be defined as needed, but are preferably systematized for ease of tooling and design of experimentation. In addition, the number, variants and location of structures within each region are designed to enable valid statistical analysis of the test results within each region and across regions to be performed.

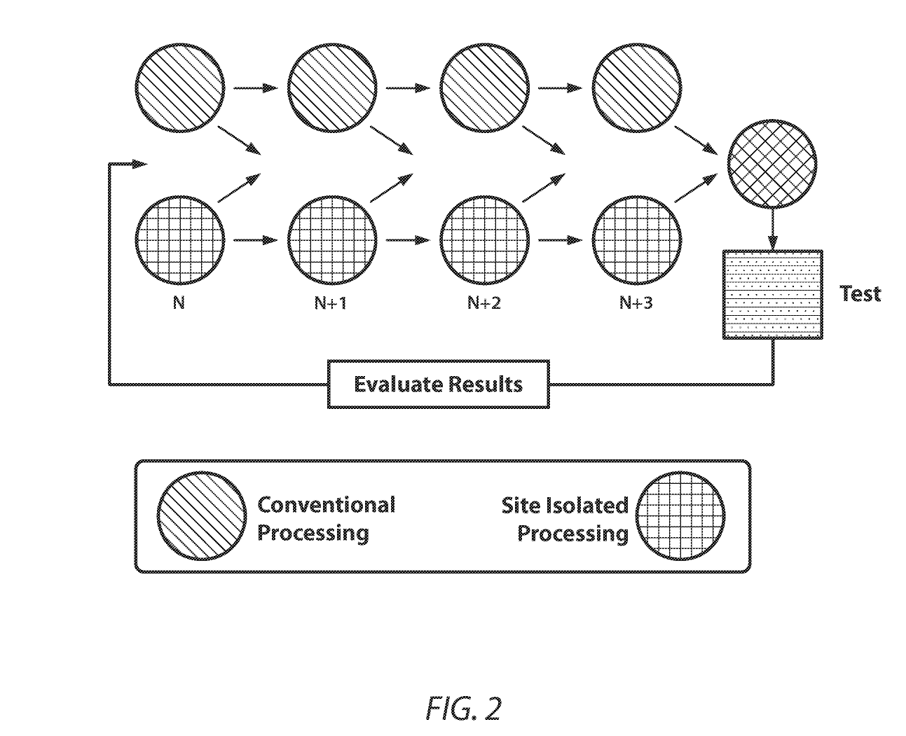

FIG. 2 is a simplified schematic diagram illustrating a general methodology for combinatorial process sequence integration that includes site isolated processing and/or conventional processing in accordance with one embodiment of the invention. In one embodiment, the substrate is initially processed using conventional process N. In one exemplary embodiment, the substrate is then processed using site isolated process N+1. During site isolated processing, an HPC module may be used, such as the HPC module described in U.S. patent application Ser. No. 11/352,077 filed on Feb. 10, 2006. The substrate can then be processed using site isolated process N+2, and thereafter processed using conventional process N+3. Testing is performed and the results are evaluated. The testing can include physical, chemical, acoustic, magnetic, electrical, optical, etc. tests. From this evaluation, a particular process from the various site isolated processes (e.g., from steps N+1 and N+2) may be selected and fixed so that additional combinatorial process sequence integration may be performed using site isolated processing for either process N or N+3. For example, a next process sequence can include processing the substrate using site isolated process N, conventional processing for processes N+1, N+2, and N+3, with testing performed thereafter.

It should be appreciated that various other combinations of conventional and combinatorial processes can be included in the processing sequence with regard to FIG. 2. That is, the combinatorial process sequence integration can be applied to any desired segments and/or portions of an overall process flow. Characterization, including physical, chemical, acoustic, magnetic, electrical, optical, etc. testing, can be performed after each process operation, and/or series of process operations within the process flow as desired. The feedback provided by the testing is used to select certain materials, processes, process conditions, and process sequences and eliminate others. Furthermore, the above flows can be applied to entire monolithic substrates, or portions of monolithic substrates such as coupons.

Under combinatorial processing operations the processing conditions at different regions can be controlled independently. Consequently, process material amounts, reactant species, processing temperatures, processing times, processing pressures, processing flow rates, processing powers, processing reagent compositions, the rates at which the reactions are quenched, deposition order of process materials, process sequence steps, hardware details, etc., can be varied from region to region on the substrate. Thus, for example, when exploring materials, a processing material delivered to a first and second region can be the same or different. If the processing material delivered to the first region is the same as the processing material delivered to the second region, this processing material can be offered to the first and second regions on the substrate at different concentrations. In addition, the material can be deposited under different processing parameters. Parameters which can be varied include, but are not limited to, process material amounts, reactant species, processing temperatures, processing times, processing pressures, processing flow rates, processing powers, processing reagent compositions, the rates at which the reactions are quenched, atmospheres in which the processes are conducted, an order in which materials are deposited, hardware details of the gas distribution assembly, etc. It should be appreciated that these process parameters are exemplary and not meant to be an exhaustive list as other process parameters commonly used in semiconductor manufacturing may be varied.

As mentioned above, within a region, the process conditions are substantially uniform, in contrast to gradient processing techniques which rely on the inherent non-uniformity of the material deposition. That is, the embodiments described herein perform the processing locally in a conventional manner, i.e., substantially consistent and substantially uniform, while globally over the substrate, the materials, processes, and process sequences may vary. Thus, the testing will find optimums without interference from process variation differences between processes that are meant to be the same. It should be appreciated that a region may be adjacent to another region in one embodiment or the regions may be isolated and, therefore, non-overlapping. When the regions are adjacent, there may be a slight overlap wherein the materials or precise process interactions are not known, however, a portion of the regions, normally at least 50% or more of the area, is uniform and all testing occurs within that region. Further, the potential overlap is only allowed with material of processes that will not adversely affect the result of the tests. Both types of regions are referred to herein as regions or discrete regions.

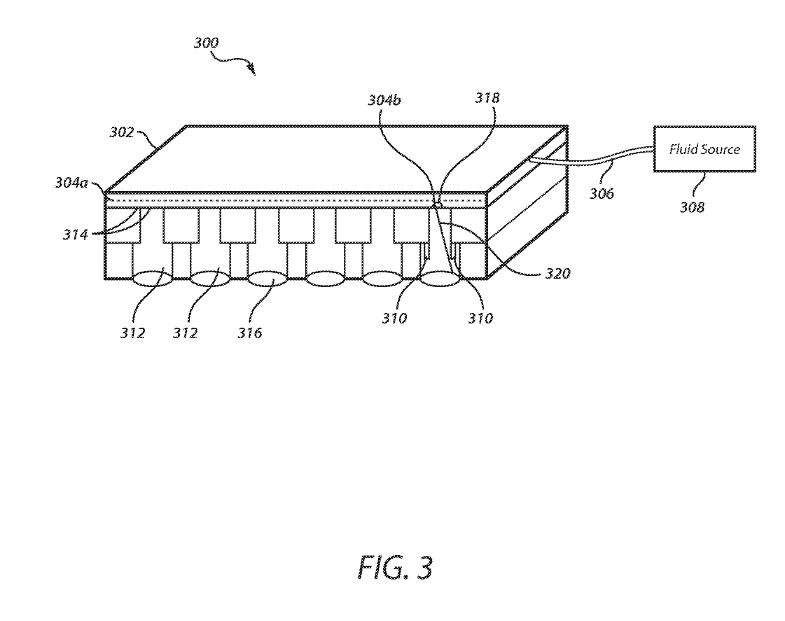

An example reactor assembly includes a plurality of reactor cells, e.g., 18 or 32 cells in some embodiments. FIG. 3 illustrates a schematic view of a reactor assembly and cleaning accessory cross-section in accordance with some embodiments. The reactor assembly and cleaning accessory cross-section of FIG. 3 for processing a region 316 of a wafer or coupon includes a plurality of reactors 312 that have a lower surface sealed against a surface of the wafer or coupon. Reactors 312 also include an upper seal sealing a bottom surface of rinse head manifold 302 to a surface of the block defining an upper portion of reactors 312. In some embodiments, reactors 312 may include a removable sleeve defining an inner side surface of the reactors.

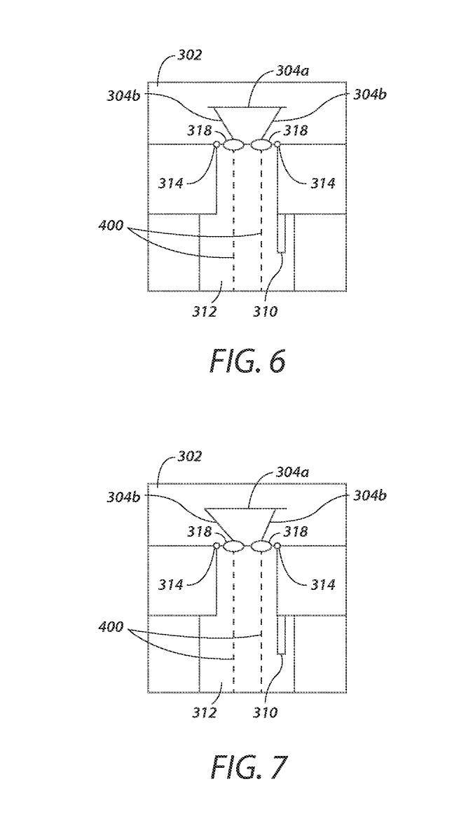

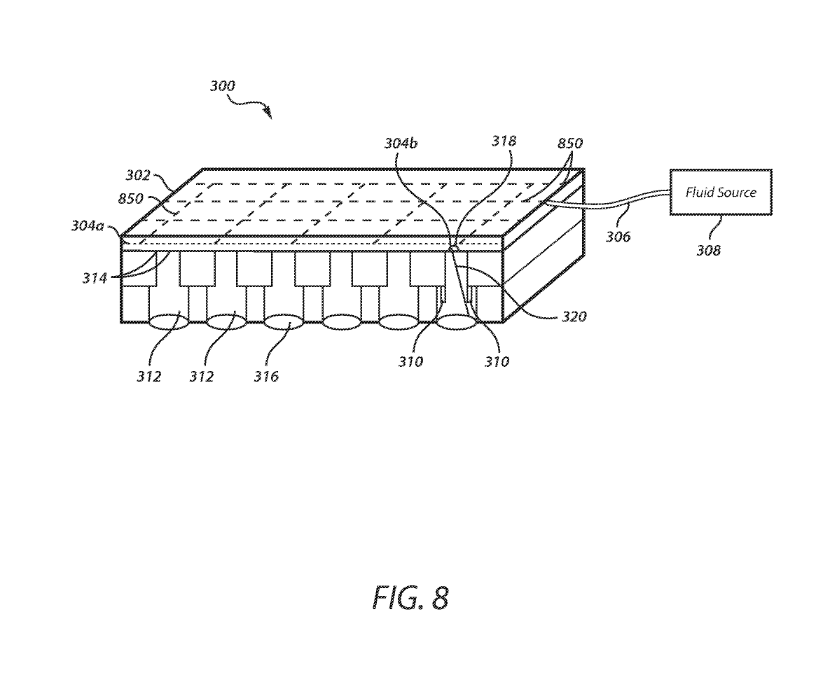

It should be appreciated that the materials of composition for the reactor assembly may be any suitable material compatible with the chemicals utilized in the combinatorial processing and may include materials such as Polytetrafluoroethylene (PTFE), aluminum, etc. In some embodiments, the cleaner accessory can be installed on the reactor assembly or overhead stirrer assembly to provide a flow of either cleaning liquid (e.g., water or organic solvent) or gas (e.g., nitrogen or CDA) to clean and/or dry the internal surfaces of these reactor components. In some embodiments, rinse head manifold 302 is a flat plate made of PTFE or another appropriate rigid, chemically-resistant material. Rinse head manifold 302 can be coupled to a supply line 306 providing a flow of liquid or gas from a fluid source 308. Rinse head manifold 302 can be cross-drilled internally allowing the flow of liquid or gas through a network of channels to the appropriate number of outlets or openings 318 defined on one of the surfaces of the rinse head manifold. Opening 318 disposed on a surface of rinse head manifold 302 is aligned with an opening of impeller shaft as described further in FIG. 5 in some embodiments. Fluid is delivered to opening 318 through channel 304a. O-ring 314 seals a surface of rinse head manifold 302 around the opening for each reactor, so that rinse head manifold 302 is removably sealed with the surface over which the rinse head manifold is disposed. O-ring 314 may be integrated into rinse head manifold 302 or the block defining the plurality of reactors 312 in some embodiments.

It should be appreciated that opening 318 may be provided with a delivery line off of channel 304a that is angled with respect to a normal to the surface of substrate 316 so that the fluid is delivered at an angle relative to the normal to the surface of the substrate in some embodiments. While reactor 312 is illustrated in FIG. 3 as having a single opening 318 with an angled delivery line, this is not meant to be limiting as the reactors may have multiple openings 318 for a single reactor that may or may not have angled delivery lines. The angled delivery line enables fluid pathway 320 to be angled relative to a normal of the surface of substrate 316. In some embodiments, rinse head manifold 302 described herein may be utilized to provide a flow of inert gas, or heated inert gas, into the reactors for drying. Tubes 310 extend into the reaction region defined within reactor 312. Tubes 310 are coupled to an external vacuum or fluid source in some embodiments. Thus, tubes 310 may be utilized to remove the cleaning fluid delivered from rinse head manifold 302. In addition, tubes 310 may be utilized to deliver cleaning solution to the reactor cell. It should be appreciated that while two tubes are illustrated in FIG. 3, more or less tubes may be incorporated into each reactor. The cleaning assembly of FIG. 3 is configured to have an array of openings 318 that are aligned with the openings for an array of reactors 312. The openings of the rinse head manifold of the cleaning assembly may or may not be in a one to one correspondence with the openings of the array of reactors.

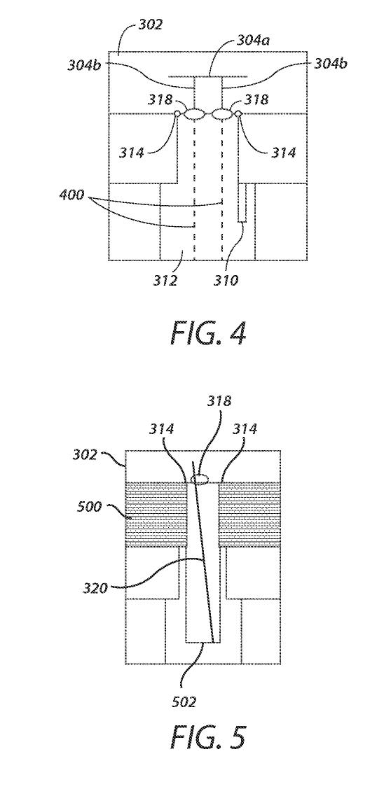

FIG. 4 is a simplified schematic diagram of a cross section of a reactor and the rinse head manifold in accordance with some embodiments. In FIG. 4 rinse head manifold 302 is disposed over a reactor block. Reactor block 312 is accessible to fluid provided through delivery lines 304a and 304b and opening 318. In this embodiment, multiple openings are provided for a single reactor 312. In addition, the fluid path 400 into reactor 312 is normal relative to a site isolated surface sealed against a bottom of reactor 312. As mentioned above this is not meant to be limiting as any number of openings 318 may be provided for each reactor and the fluid path 400 may be angled or normal relative to a site isolated surface at the bottom of the reactor. O-ring 314 seals reactor cell 312 so that cleaning fluid is prevented from accessing a region external to the reaction region of the reactor or overfilling the reactor. In some embodiments, tube 310 assists in preventing overfilling of reactor 312. It should be appreciated that the cleaning assembly described herein may be integrated into any suitable reactor block and is not limited to the reactor blocks illustrated in FIGS. 3 and 4.

FIG. 5 is a simplified schematic diagram illustrating a cross section of a reactor and the rinse head manifold in accordance with some embodiments. In the embodiment of FIG. 5, impeller 502 is supported by block 500 and the impeller extends into the reaction region of the reactor. Rinse head manifold 302 is removably sealed against the surface of block 500 through o-rings 314. Impeller 502 may function as a delivery tube into the reactor as well as a stirring device. In some embodiments, impeller 502 may rotate as fluid is delivered through fluid path 320. The fluid may be utilized to clean the inner surfaces of impeller 502 and also allowed to flow into the reactor to clean the inner surfaces of the reactor. In some embodiments, tube 310 of FIGS. 3 and 4 may be incorporated into FIG. 5 to prevent overfilling a volume of the reactor and possible overflow into a stirrer gear box incorporated into block 500 driving the rotation of impeller 502. It should be appreciated that openings 318 may be circular in shape but this is not meant to be limiting as the openings can have any shape as long as openings 318 are smaller than an opening of the reactor blocks or an impeller that the opening is aligned with.

When compared to existing methods, the embodiments described can provide a flow of liquid or gas for cleaning and/or drying directly to all potentially contaminated hardware components, in a manner that provides less potential for damage or wear and tear to hardware components and/or that is more time-efficient and labor-saving. The embodiments provide a cleaning assembly with dimensions and a grid layout uniquely suited to the cleaning of process equipment having a closely spaced array of small openings (e.g., reactor cells). It should be appreciated that the embodiments described herein where the rinse head manifold provides a flow of fluid into each reactor provides for reliable and efficient cleaning In contrast, adding rinse deionized water (DIW) or any other cleaning chemistry to the reactors using the same dispense mechanism as the original process chemistry may not clean all of the internal surfaces, since the dispense volume is limited and relatively small compared to the reactor volume. It should be appreciated that an overflow technique achieved through repeated dispensing of the small volume through the same dispense mechanism as the original process chemistry into the reactors may cause cross-contamination in other parts of the tool. Additionally, adding rinse DIW through the same dispense mechanism as the original process chemistry assumes that the dispense unit is also clean, which may not be a good assumption. Filling rinse DIW from the bottom of the reactor until the DIW reaches the top of the impeller is not an attractive solution as compared to the present embodiments as an overflow into the overhead stirrer gear box occurs and causes cross-contamination because there is no seal on the outside of the impeller. Because the impeller needs to rotate at a relatively high rotation per minute ball bearings that can't be sealed are employed. The embodiments described herein use a removable cleaning head or rinse head manifold that injects DIW (or other cleaning chemistry) into each stirrer or reactor while creating a seal at the top of the reactor which prevents external leaks and eliminates cross-contamination both internal and external to the impeller, when there is an impeller. The DIW/cleaning chemistry source should be large enough to supply chemistry for at least 1 minute at a high flow rate, e.g., a flow rate sufficient to fill the internal volume of the impeller. In the embodiments described above a continuous supply of DIW is built into the tool and the tubes extending into the reactor can be utilized to prevent any overflow. The continuous supply of cleaning chemistry such as DIW may be supplied through a pump or a pressurized fluid source in some embodiments.

Those skilled in the art will appreciate that many modifications to the exemplary embodiments are possible without departing from the spirit and scope of the present invention. In addition, it is possible to use some of the features of the present invention without the corresponding use of the other features. Accordingly, the foregoing description of the exemplary embodiments is provided for the purpose of illustrating the principles of the present invention, and not in limitation thereof, since the scope of the present invention is defined solely by the appended claims.

1. A reactor assembly, comprising:
a first block having an array of reactors defined therein; and
a second block having an array of openings defined within a surface of the second block, the array of openings aligned with openings of the array of reactors so that each reactor is associated with at least one corresponding opening defined within the surface of the second block when the surface of the second block is placed on a surface of the first block; and
a network of channels defined within the second block, the network of channels in fluid communication with a fluid source defined within the second block, wherein the network of channels is configured within the second block to provide a continuous flow of fluid through the network of channels to each of the reactors.

2. The assembly of claim 1, wherein a diameter of each opening of the array of openings is less than a diameter of each of the reactors.

3. The assembly of claim 1, further comprising a delivery line for each opening of the array of openings which are angled with respect to a normal axis of the surface of the second block.

4. (canceled)

5. (canceled)

6. The assembly of claim 1, further comprising a delivery line for each of the array of openings in the second block which are angled differently relative to each other.

7. (canceled)

8. The assembly of claim 1, further comprising an o-ring integrated into the first block.

9. The assembly of claim 1, further comprising an o-ring integrated into the second block.

10. The assembly of claim 1, further comprising a tube extending into each reactor of the array of reactors, the tubes coupled to a vacuum source.

11. A cleaner assembly for a reactor assembly having an array of reactors defined therein, comprising:
a flat plate having an upper surface and a lower surface and mountable on the reactor assembly;
an array of openings defined within the lower surface;
a network of channels defined within the flat plate, wherein the flat plate is removably sealed against a surface defining an opening for each reactor of the array of reactors; and
a fluid source coupled to the network of channels, the fluid source operable to provide a continuous flow of fluid through the network of channels to each opening of the array of openings.

12. The cleaner assembly of claim 11 wherein multiple openings of the plurality of openings provides fluid to one of the array of reactors.

13. The cleaner assembly of claim 12 wherein a delivery line for each one of the multiple openings is angled differently relative to each other.

14. The cleaner assembly of claim 12 wherein a diameter of each opening of the multiple openings is different.

15. The cleaner assembly of claim 11 wherein the lower surface of the flat plate is removably sealed against a surface defining an opening for each reactor of the array of reactors through an o-ring.

16. The cleaner assembly of claim 11 wherein a delivery line for each opening of the array of openings is angled with respect to a normal axis of the lower surface.

17. The cleaner assembly of claim 11, wherein the fluid is deionized water.

18. The cleaner assembly of claim 11, wherein each reactor of the array of reactors includes a tube extending into the reactor, the tube coupled to a vacuum source.

19. The cleaner assembly of claim 11, wherein each reactor includes an impeller.

20. The cleaner assembly of claim 19, wherein an opening of the array of openings is aligned with a corresponding opening of the impeller.
